(19) United States
(12) Patent Application Publication
(10) Pub. No.: US 2004/0149007 A1
(43) Pub. Date: Aug. 5, 2004

(54) Sample handling system with solvent washing

(76) Inventor: Stephen Staphanos, Long Beach, CA (US)

Correspondence Address: Christopher R. Christenson, WESTMAN, CHAMPLIN & KELLY, P.A., International Centre - Suite 1600, 900 Second Avenue South, Minneapolis, MN, 55402-3319, US

(21) Appl. No.: 10/358,100

(22) Filed: Feb. 4, 2003

(51) Int. Cl. G01N 1/34; G01N 1/38

(52) U.S. Cl. 73/23.31; 73/31.07

(57) ABSTRACT

A sample handling system includes an inlet for receiving sample from a process, and a mixer for intermixing a solvent with the sample to dissolve undesirable components within a sample. A separator is provided that receives the solvent/sample mixture and separates the sample from the solvent and undesirable solutes. The so separated sample is then provided to a suitable analyzer for analysis.

### BACKGROUND OF THE INVENTION

Process analytic systems are used in a variety of industries to measure process characteristics in substantially real-time. Such industries include the chemical, petrochemical, pipeline, and pharmaceutical industries. Process analytic systems are often used for process gas analysis, combustion analysis and control, and emissions monitoring in any of the above industries.

Process analytic systems differ substantially from laboratory analyzers in the manner in which sample handling is effected. For example, samples are usually held as a gas or liquid in an appropriate container that is transported, sometimes by hand, to a laboratory analytical instrument. In contrast, the process analytic system receives its sample directly from a sampling point in the process, without human assistance. Process analytic systems can include a process analyzer and a process sample handling system.

For a process analyzer in a process analytic system, such as a process gas chromatograph, to provide an accurate analysis of the process, it is important to convey the sample from the process to the analyzer such that the sample is representative of the process. Since any number of variables can affect the extent to which the sample represents the process, it is desirable to control many variables including temperature, pressure and flow while conveying the sample to the analyzer. Further complicating matters is the fact that the sample may be quite hot and under considerable pressure, contain water vapor, solids, condensed liquid, acids and/or other substances, etc. One example of a known process analyzer is the Continuous Analyzer Transmitter, available from Rosemount Analytical, Inc., of Anaheim, Calif. Another example of a known process analyzer is the Model GCX Process Gas Chromatograph, available from Rosemount Analytical, Process Analytic Division, of Orrville, Ohio.

A process sample handling system is utilized in a process analytic system to extract a process sample from a sampling point and convey the sample to a process analyzer. Generally, the sample handling system includes all requisite components to maintain a constant sample flow to the analyzer. Thus, the sample handling system generally includes suitable pressure reduction components, filters, vaporizers, flow controls, and sample switching or selector valves for introducing multiple sample streams or a calibration standard to the process analyzer. With the exception of vaporizers, filters, and pressure reducers, most components of the sample handling system are usually located near the process analyzer, and sometimes within the same housing as the analyzer. The process sample handling system is an important component of an effective process analytic system. If the process sample is not delivered to the process analyzer in a condition that is representative of the process, errors will occur in the analysis. Many of the problems encountered in process analytic systems can be traced to a problem occurring in the process sample handling system.

Many industrial samples encountered by the sample handling system contain a number of substances which are not of interest, but which nonetheless may not only adversely affect accuracy of the analysis, but also accelerate deterioration of the sample handling system and/or associated analyzer. Examples of such substances include hydrochloric acid (HCL), chlorine gas, sulfuric acid (H₂SO₄), as well as various solids. These substances not only reduce the quality of analysis, but also cause accelerated deterioration on the process analytic system itself. A system which could ameliorate the effects of such substances on both analyses and analytic system itself, would be highly beneficial to the act of process analysis.

### SUMMARY OF THE INVENTION

A sample handling system includes an inlet for receiving sample from a process, and a mixer for intermixing a solvent with the sample to dissolve undesirable components within a sample. A separator is provided that receives the solvent/sample mixture and separates the sample from the solvent and undesirable solutes. The so separated sample is then provided to a suitable analyzer for analysis.

### BRIEF DESCRIPTION OF THE DRAWINGS

FIG. 1 is a diagrammatic view of a process analytic system in accordance with an embodiment of the present invention.

FIGS. 2 and 3 are diagrammatic views of a sample probe in accordance with embodiments of the present invention.

### DETAILED DESCRIPTION OF THE PREFERRED EMBODIMENTS

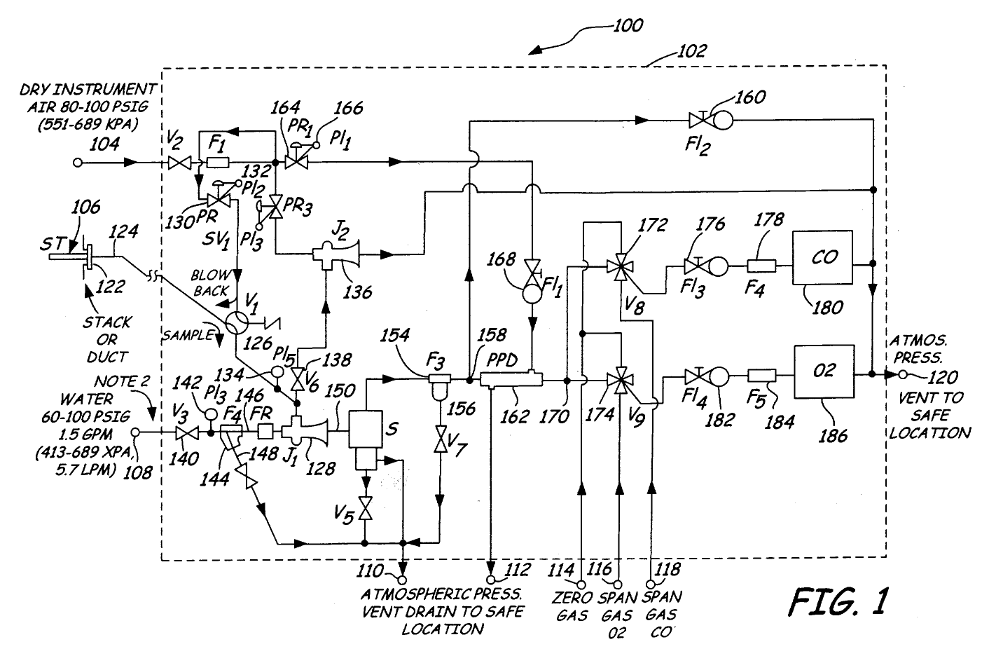

FIG. 1 is a diagrammatic view of a sample handling system for measuring carbon monoxide and oxygen in accordance with embodiment of the present invention. Although the system shown in FIG. 1 will be described with respect to a specific solvent (water) and water-soluble substances, it is expressly contemplated that other solvent/solute combinations can be used in accordance with embodiments of the present invention.

System 100 includes enclosure 102, air inlet 104, sample probe 106, solvent inlet 108, drain 110, vent 112, zero gas inlet 114, span gas inlet 116 and 118, and vent 120. Sample probe 106 is generally disposed at or within a stack or process line and is adapted to receive a relatively small amount of sample from within the stack or process line. The sample is conveyed along line 124 into enclosure 102 and subsequently to four-way valve 126. Preferably, line 124 is sized to have an outer diameter ranging from approximately 9.53 millimeters to approximately 12.7 millimeters. Additionally, it is preferred that line 124 be constructed from a corrosion resistant tubing and physically adapted to slope from stack or duct 122 toward the inlet of mixer 128. Such sloping is illustrated diagrammatically by the diagonal line. In embodiments where sample handling system 100 will be exposed to subfreezing temperatures, line 124 can be provided with heating elements and insulation as desired. In FIG. 1, valve 126 is illustrated fluidically coupling sample probe 106 to mixer 128 (also referred to herein as jet pump 128). An alternate port coupling of valve 126 is shown with dashed lines wherein, upon actuation, dry instrument air is coupled to sample probe 106 to essentially provide a blow-back function. The blow-back airflow is determined in part by pressure regulator 130. Pressure indicator 132 indicates the blow-back pressure as set by pressure regulator 130.

The pressure within sample line 124 downstream from valve 126 is indicated by pressure indicator 134. Sample is provided to jet pump 128, and optionally to jet pump 136 based upon actuation of shut-off valve 138. Jet pump 128 receives solvent (water) from port 108 through shut-off valve 140. The pressure of solvent provided to jet pump 128 is indicated by pressure indicator 142. As illustrated, solvent in the preferred embodiment is water provided to port 108 at a pressure ranging between approximately 413 kpa to approximately 689 kpa at a rate of 5.7 liters per minute. Preferably, solvent is filtered at y-strainer 144 which provides filtered solvent on lines 146 and 148. The solvent entering jet pump 128 actually causes jet pump 128 to draw sample from the process. The exhaust of jet pump 128 is provided on line 150 and generally consists of a mixture of solvent and sample that flows to gas/liquid separator 152 where gas is separated from the solvent (water or steam). In embodiments where the solvent is steam or water, this process removes particulate and undesirable corrosive water-soluble components, such as SO₂, SO₃, NOₓ, HCL, H₂SO₄, CL₂, etc.

Sample is then provided from gas/liquid separator 152 to coalescing filter 154. Coalescing filter 154 is preferably a 0.6 micron filter that further removes additional water or steam. The water or steam so removed by coalescing filter 154 is provided to drain 110 through shut-off valve 156. The sample filtered by coalescing filter 154 is split at node 158 with some flow being provided to vent 120 through flow meter 160, while other flow is provided to air-dryer 162. As illustrated, air-dryer 162 receives dry instrument air, the pressure of which is controlled by pressure regulator 164 (indicated by pressure indicator 166), and the flow rate of which is determined by flow meter 168. Essentially, dry instrument air interacts with the filtered sample stream in dryer 162 to thereby further dry the sample stream. Dry instrument air continues on through dryer 162 and out vent 112. Preferably, dryer 162 is a commercially available, such as those sold by Perma Pure Inc., of Toms River, N.J. The sample stream flowing from dryer 162 is split at node 170 with some sample flowing into five-way manual valve 172 and some sample flowing into five-way manual valve 174. When five-way manual valve 172 is suitably actuated, sample flows through flowmeter 176 and guard filter 178 into carbon monoxide detector 180. Carbon monoxide detector 180 provides an output (not shown) that is indicative of the quantity of carbon monoxide flowing therethrough.

In a similar fashion, when five-way manual valve 174 is suitably actuated, sample flows through flowmeter 182, through guard filter 184 and into oxygen detector 186. Oxygen detector 186 provides an output (not shown) that is indicative of quantitative oxygen content in the sample stream.

Those skilled in the art will recognize that while not necessary for practicing embodiments of the present invention, the provision of jet pump 136 reduces sample lag time through the system. In preferred embodiments, this lag time is reduced to less than 10 seconds per 100 feet using a 9.53 millimeter outside diameter sample line. Those skilled in the art will also recognize that by suitably adjusting flow meters 160, 176 and 182 adjustment for sample flow rate and system lag time are provided.

Zero gas is provided through port 114 to five-way manual valve 172 while span gas (CO) is provided through inlet 118 to five-way manual valve 172. In this manner, manual actuation of valve 172 can fluidly couple either zero gas or span gas to detector 180 for calibration and diagnostics. Similarly, zero gas is also provided to five-way valve 174, while span gas (O₂) is provided through inlet 116 to five-way manual valve 174. Thus, actuation of valve 174 can selectively couple zero gas, or span gas to oxygen detector 186 for calibration and/or diagnostics.

It is preferred that materials in contact with the sample be selected to withstand such contact. Suitable materials include stainless steel, polytetrafluoroethylene, polycarbonate, bun-N polypropylene, and polyvinyl chloride. Further still, it is preferred that the sample probe 106 is constructed from an open tube of material such as Hastelloy C alloy available from Haynes International Inc., of Kokomo Ind., or 316 stainless steel.

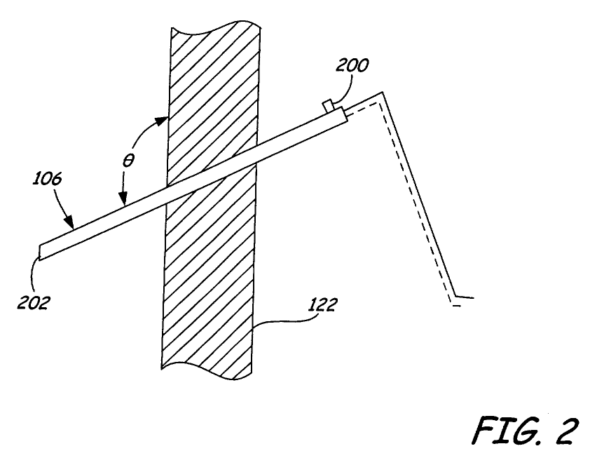

FIG. 2 illustrates sample probe 106 configured to obtain a sample from an environment that generally has a number of solids mixed with the sample. Such environments include, but are not limited to, glass furnaces, cement plants, and lime kilns. Probe 106 is passes through stack or duct wall 122 at such an angle θ (theta) which is selected to be between about 120 and 135 degrees. Probe 106 also includes solvent inlet 200, which is coupleable to a source of solvent, preferably water, to allow the solvent to intermix with sample within probe 106 while also cooling probe 106. Due to the angle at which probe 106 is disposed, excess solvent will drain from probe tip 202 along with undesirable solids by virtue of gravity.

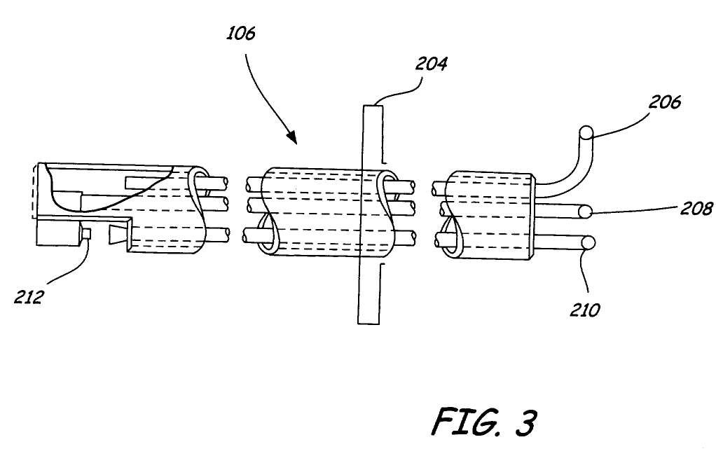

FIG. 3 is a more detailed diagrammatic view of probe 106 in accordance with embodiments of the present invention. Probe 106 includes flange 204 for mounting to a process stack or duct wall. Probe 106 includes couplings 206, 208 and 210, for solvent, gas out, and gas in, respectively. A source of solvent, not shown in FIG. 3, is connected to coupling 206 such that solvent is passed through probe 206 ultimately emerging from spray nozzle 212. Preferably the path of solvent through probe 106 is somewhat circuitous to allow the solvent to cool the probe, which may be exposed to sample temperatures easily ranging from less than 0 degrees Celsius to well over 1000 degrees C. As described above, it is advantageous to mix the incoming sample with a solvent, and nozzle 212 facilitates such function. Coupling 208 is a gas inlet for probe 108 and can be selectively coupled to a source of zero gas or span gas, as desired. Coupling 208 is a gas outlet that provides the sample and mixed solvent to the process instrument for analysis.

Although the present invention has been described with reference to preferred embodiments, workers skilled in the art will recognize that changes may be made in form and detail without departing from the spirit and scope of the invention.

What is claimed is:

1. A process analytic system comprising:
a sample handling system adapted to couple to a process analyzer, the system comprising:
a sample probe for receiving a sample;
a solvent inlet coupleable to a solvent source;
a mixing device coupled to the sample probe and the solvent inlet, the mixing device adapted to intermix a sample stream with solvent to dissolve at least one undesirable solute into solution;
a separation device coupled to the mixing device to remove the solvent and solutes from the sample stream; and
at least one analyzer coupled to the separation device to receive that sample and provide an analytical output based upon the sample.

2. The system of claim 1, wherein the solvent is water.

3. the system of claim 1, wherein the solvent is steam.

4. The system of claim 1, wherein the at least one analyzer comprises first and second analyzers, the first analyzer providing an output related to quantitative analysis of carbon monoxide within the sample, and the second analyzer providing an output related to quantitative analysis of oxygen in the sample.

5. The system of claim 1, and further comprising a coalescing filter interposed between the separation device and the at least one analyzer to remove solvent from the sample.

6. The system of claim 5, and further comprising a dryer disposed inline with the coalescing filter to dry the sample using a flow of dry gas.

7. The system of claim 1, and further comprising a dryer interposed between the separation device and the at least one analyzer to dry the sample using a flow of dry gas.

8. The system of claim 1, wherein the mixing device is a jet pump.

9. A method of analyzing a process sample, the method comprising:
removing a sample stream from a process;
mixing the sample stream with a solvent to cause at least one undesirable solute to go into solution;
separating the sample stream from the solvent and solute; and
analyzing the separated sample stream.

10. The method of claim 9, wherein the mixing the sample stream with a solvent includes mixing the sample stream with water.

11. The method of claim 9, wherein the mixing the sample stream with a solvent includes mixing the sample stream with steam.

12. The method of claim 9, wherein analyzing the sample stream includes measuring quantitative oxygen content in the sample stream.

13. The method of claim 9, wherein analyzing the sample stream includes measuring quantitative carbon monoxide content in the sample stream.

14. The method of claim 13, wherein analyzing the sample stream includes measuring quantitative oxygen content in the sample stream.

15. The method of claim 9, and further comprising drying the separated sample stream before analysis.

16. The method of claim 15, wherein drying comprises using a source of dry gas to remove solvent from the sample stream.

17. A process analytic system comprising:
a sample handling system adapted to couple to a process analyzer, the system comprising:
a sample probe for receiving a sample;
a solvent inlet culpable to a solvent source;
means for removing at least one undesirable solvent from the sample stream; and
at least one analyzer coupled to the means for removing to receive the sample and provide an analytical output based upon the sample.
